(19) United States
(12) Patent Application Publication
(10) Pub. No.: US 2007/0194221 A1
(43) Pub. Date: Aug. 23, 2007

(54) Alpha track detector with foldable semicircle ring

(76) Inventor: Young-Woong Park, Daejeon (KR)

Correspondence Address: BROOKS KUSHMAN P.C., 1000 TOWN CENTER, TWENTY-SECOND FLOOR, SOUTHFIELD, MI, 48075, US

(21) Appl. No.: 10/599,021

(22) PCT Filed: Mar. 17, 2005
(86) PCT No.: PCT/KR05/00771

§ 371 Date: Sep. 18, 2006

(30) Foreign Application Priority Data
Mar. 17, 2004 (KR) 20-2004-0007325

(51) Int. Cl. H05H 3/02

(52) U.S. Cl. 250/251

(57) ABSTRACT

This invention is a radon detector for measuring the time integral concentration of radon in air and the emission rate from various kind of materials. The detector is designed with a foldable semicircle ring (4) in order to install the detector at the heigh suggested from the specialist using thread or wire without any other tools at the site. The detector is designed 3 components in order to exchange the SSTD without open the filtering part (1).

### TECHNICAL FIELD

This invention relates to the field of alpha track detector for measuring the time integral concentration of radon which is a gaseous element from decay of radium.

### BACKGROUND ART

The alpha track detector for measuring the concentration of radon is using solid state track detector, LR-115 and CR-39 are the trade name of SSTD(stand for solid state track detector). During the measuring period some tracks are created on the surface on the SSTD by the alpha particles emitted from the radon and it's daughters. The depth from alpha particles are about tens micro meters degree on the SSTD.

The tracks by alpha particles on the SSTD can't be readable In spite of optical microscope, so the SSTD should do etching to enlarge the tracks for distinction by optical microscope, with the condition between 10% and 25% NaOH aqueous solution at a temperature between 40° C. and 60° C. during 1 hour to 6 hours. The tracks can be readable by the microscope or automatic readout system after etching, and the average number of tracks in the united area (tracks/ [symbol] ) can be converted to the concentration of radon by a conversion factor coming from in advance.

TABLE 1
Methods of Various Radon Detection in Air

| | Time Integral | Grab Sampling | |
|---|---|---|---|
| Sections | Method | Method | Continuous Method |
| Target of | Average Con- | Radon and Radon | Real Time Moni- |
| Measurements | centration of | DaughtersWL(Working | toring the Con- |
| | Radon | Level)Equilibrium | centration of |
| | | Factor | Radon |
| Duration | about 3 | Several Times a | Continuous |
| | MonthsIntegral | Day | |
| | Period | | |
| Trade Names | Rad-Trak, E- | RAD-200 | RM-1027RAD-7EQ |
| of Detectors | premCharcoal | | F-3000 |
| | Canisterα-track, | | |
| | etc . . . | | |
| Related | CR_{N} = K1 × T/D | CR_{N} = K2 × N_{CPM} | CR_{N} = K3 × N_{CPM} |
| Equations | | | |

The principal of enlargement the tracks by etching is the difference of etching rate at the point of incidence of alpha particle from the circumference medium of the SSTD.

Setting point to install the alpha track detector is recommended between 1.5 m and 2.5 m above from the floor, and about 30 cm depart from the ceiling or the wall. But almost all of the alpha track detectors suspend by a paper tape (401) or a metal rod (402) in existing, and the other tool (321, 322) must be prepared to fix the radon detectors. Besides, the alpha track detector have an inconvenient to use because of the transportation of the detector to the lab located far away from the site.

TABLE 2
Etching Conditions of two SSTDs.

| Sections | Molecular Formulas | Etching Conditions |
|---|---|---|
| LR-115 | C6H8O9N2 | 10%-NaOH, 60° C. 150 min |
| CR-39 | C12H18O7 | 25%-NaOH, 60° C. 360 min |

### DISCLOSURE OF INVENTION

Technical Problem

The position of setting the alpha track detector is recommended between 1.5 m and 2.5 m from the floor, but the detector using the paper tape or the metal rod length about 30 cm in existing is hard to keep the recommendation, because of the variety of the height from the floor to the ceiling in the field.

After the period for measuring of radon in site, the alpha track detectors must be send to the lab by mail, because the SSTD inside the detector should do chemical etching for reading. The filter is damaged at this operation in existing.

The number of tracks per unit area on the etched SSTD is above 10% high at the center area compares to the side area, so the precision of the data could be lower and lower if the reading area of SSTD is larger and larger.

Technical Solution

For the purpose to overcome these inconvenience, this invention is designed of 3 sections, detecting part, filtering part, and connecting part. The SSTD in the detecting part can be put in and take out without open the filtering part, and a set of SSTD-holders located at the center of detecting part can make the SSTD smaller than that in existing.

This invention have a foldable semicircle ring (4) of diameter between 10 mm and 50 mm with a hole (41) of diameter between 1 mm and 4 mm, in order to able to install the detector easily at the height recommended from the special agency using thread or wire without any other tools.

The detecting area of this invention have a set of SSTD-holders which hold the SSTD tightly at the center, and the distance from the side of SSTD to the tangent line of the detector is between 5 mm and 20 mm.

Advantageous Effects

Using this invention, \hat{1}the alpha track detector can be installed easily at the height recommended from the special agency using thread or wire without paper tape or metal rod and any other tools, \hat{2}the main body of alpha track detector can be reused and the volume of package to transport can be reduced, \hat{3}the precision of measurement can be raised in spite of saving the SSTD used.

### BRIEF DESCRIPTION OF THE DRAWINGS

FIG. 1 Front view of this invention, the semicircle ring is folded at the left view and unfolded at the right view.

FIG. 2 Top side view and bottom side view of this invention.

FIG. 3 Cross section view of this invention with a SSTD installation.

FIG. 4 Cross section view of a alpha track detector with a SSTD installation in existing.

FIG. 5 Two types of installation of alpha track detectors in existing.

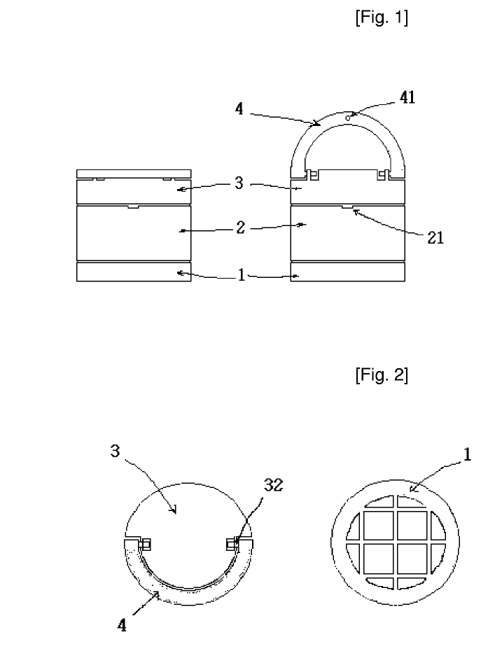

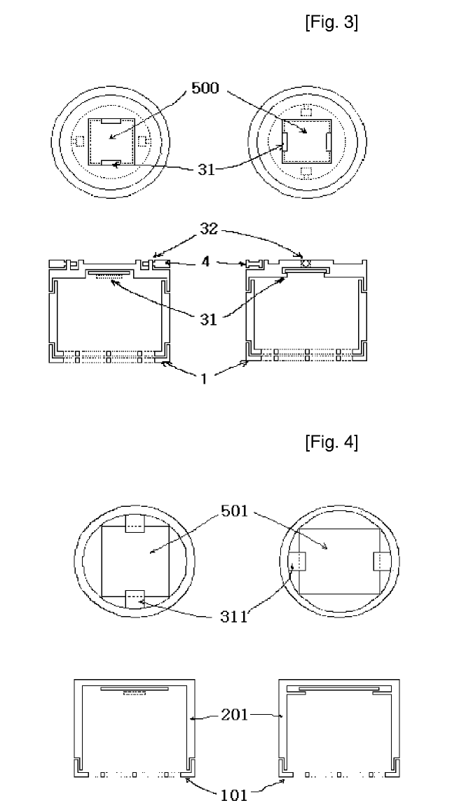

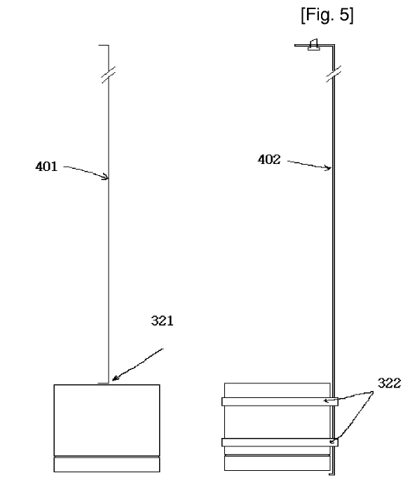

### DETAILED EXPLANATION OF DRAWINGS

1: A filter holder for supporting the filter and providing the surface to adhere a circular tape in order to prevent damage of the filter during transport, the gas state radon without radon daughters can enter the inside the detector through the filter media.

101: A shape of filter holder of alpha track detector in existing.

2: Connecting part in order to connect the detecting part and the filtering part without contact each parts directly.

21: A groove to separate the detecting part from the body using thumb nail easily.

201: A shape of body of alpha track detector in existing.

3: The top department of this invention, which is composed of a set of supporters with a semicircle ring, and a set of SSTD-holders on the other side.

31: A set of SSTD-holders to fix a SSTD in the detecting part.

32: A set of supporters in order to fix a semicircle ring in the detecting part.

311: A shape of SSTD-holder of alpha track detector in existing.

321: Adhesive part for fixing the detector to the paper tape in existing.

322: Cable ties for fixing the detector to the metal rod in existing.

4: A semicircle ring to set this invention in site using thread or wire.

41: A hole for inserting thread or wire to the semicircle ring.

401: A shape of hanger made by paper tape in order to pending the detector to the ceiling in existing.

402: A shape of hanger made by metal rod in order to pending the detector to the ceiling in existing.

500: A solid state track detector which stands for SSTD.

501: A shape of SSTD of alpha track detector in existing.

### Mode for the Invention

This invention is designed to cylindrical with 4 cm diameter and 3 cm depth, which is the result of consideration of the range of alpha particles emitted from radon in air and in SSTD.

The top of this invention corresponded to the detecting part (3) is composed of a set of SSTD-holders (31) to fix a SSTD (500) for the detection of alpha particles emitted from radon which comes in from out air to the detector through the filter, and a set of supporters (32) holding a semicircle ring (4) with a hall (41) in order to suspend the detector from the ceiling using thread or wire.

The bottom of this invention corresponded to the filtering part is composed of a filter in order not to permeate the radioisotope without radon inside the detector, and a cover (1) not to damage the filter during transportation by sticking the circular tape.

The middle of this invention corresponded to the connecting part (2) have a groove (21) in order to separate the detecting part (3) from the body by thumb nail easily.

1. An alpha track detector for measuring a time integral concentration of radon, comprising:
a detecting part:
a connecting part: and
a filter holder.

2. The detector of claim 1, wherein the detecting part has a foldable semicircle ring outside with a hole diameter from 1 mm to 4 mm, and a set of SSTD-holders with an inside distance from 5 mm to 20 mm from the tangent line of the detector's inner edge.

3. The detector of claim 1, wherein the connecting part includes a supporter of filter which coincides with the filter holder.
